(19) United States
(12) Patent Application Publication
(10) Pub. No.: US 2026/0095032 A1
(43) Pub. Date: Apr. 2, 2026

(54) COMBINER CABINET AND ENERGY STORAGE SYSTEM

(71) Applicants: EVE ENERGY CO., LTD., Huizhou (CN); Eve Energy Storage Co., Ltd., Wuhan (CN); EVE POWER CO., LTD., Jingmen (CN)

(72) Inventors: Jianhua LIU, Huizhou (CN); Houpo XIA, Huizhou (CN); Zihui ZHAO, Huizhou (CN); Haohao YI, Huizhou (CN)

(73) Assignees: EVE ENERGY CO., LTD., Huizhou (CN); Eve Energy Storage Co., Ltd., Wuhan (CN); EVE POWER CO., LTD., Jingmen (CN)

(21) Appl. No.: 19/375,165

(22) Filed: Oct. 30, 2025

Related U.S. Application Data
(63) Continuation of application No. PCT/CN2024/142322, filed on Dec. 25, 2024.

(30) Foreign Application Priority Data
Sep. 30, 2024 (CN) 202422411075.0

(51) Int. Cl. H02B 1/32; H02B 1/04; H02B 1/30

(52) U.S. Cl. CPC H02B 1/32; H02B 1/04; H02B 1/306

(57) ABSTRACT

An energy storage system is provided with a combiner cabinet. The combiner cabinet includes: a cabinet body provided with both a first isolation chamber and a second isolation chamber, and a cabinet door pivotally connected to the cabinet body and configured to enclose the first isolation chamber and the second isolation chamber; where the first isolation chamber and the second isolation chamber are arranged in a preset first direction, the first isolation chamber is provided with a first power distribution module, the second isolation chamber is provided with an uninterruptible power supply, and the uninterruptible power supply is disposed close to the bottom of the cabinet body and configured as a backup power supply.

### CROSS REFERENCE TO RELATED APPLICATION

This application is a continuation of an International Application No. PCT/CN2024/142322, filed on Dec. 25, 2024, which claims priority to Chinese Patent Application No. 202422411075.0, filed on Sep. 30, 2024, the disclosures of which are incorporated herein by reference in their entireties.

### TECHNICAL FIELD

The present disclosure relates to the field of battery technologies, and more particular to a combiner cabinet and an energy storage system.

### BACKGROUND

A battery prefabricated cabin battery energy storage system is typically equipped with a battery management system that is capable of monitoring in real time data such as a voltage and a temperature of each cluster of batteries, each module, and each cell of the cabin and a voltage and a current of a cluster of batteries and capable of controlling a circuit breaker or a switch within the cabin to be turned off in response to a fault. The battery prefabricated cabin battery energy storage system not only improves the safety of the system, but also enhances the operation efficiency and stability thereof.

### SUMMARY

In a first aspect, the present disclosure provides a combiner cabinet, including: a cabinet body provided with both a first isolation chamber and a second isolation chamber; and a cabinet door pivotally connected to the cabinet body and configured to enclose the first isolation chamber and the second isolation chamber; where the first isolation chamber and the second isolation chamber are arranged in a preset first direction, the first isolation chamber is provided with a first power distribution module, the second isolation chamber is provided with an uninterruptible power supply, and the uninterruptible power supply is disposed close to the bottom of the cabinet body and configured as a backup power supply of the battery management system.

In a second aspect, the present disclosure further provides an energy storage system, including: the combiner cabinet provided in the first aspect.

### BRIEF DESCRIPTION OF THE DRAWINGS

FIG. 1 is a first schematic structural view of a combiner cabinet according to the present disclosure.

FIG. 2 is a second schematic structural view of a combiner cabinet according to the present disclosure.

FIG. 3 is a third schematic structural view of a combiner cabinet according to the present disclosure.

FIG. 4 is a fourth schematic structural view of a combiner cabinet according to the present disclosure.

FIG. 5 is a fifth schematic structural view of a combiner cabinet according to the present disclosure.

FIG. 6 is a sixth schematic structural view of a combiner cabinet according to the present disclosure.

FIG. 7 is a front diagram of a cabinet door according to the present disclosure.

FIG. 8 is a front diagram of a cabinet body according to the present disclosure.

### DETAILED DESCRIPTION

In the related art, the battery cabin occupies a larger space in the battery prefabricated cabin, so that the space of the electric cabin is compressed, an Uninterruptible Power Supply (UPS) cannot be arranged in a combiner cabinet of the electric cabin, or after the uninterruptible power supply is arranged, the uninterruptible power supply cannot be effectively maintained to cause poor reliability and safety of the battery prefabricated cabin battery energy storage system.

To solve the technical problem of the poor reliability and safety of the energy storage system as mentioned in the present disclosure, the present disclosure provides a combiner cabinet and an energy storage system.

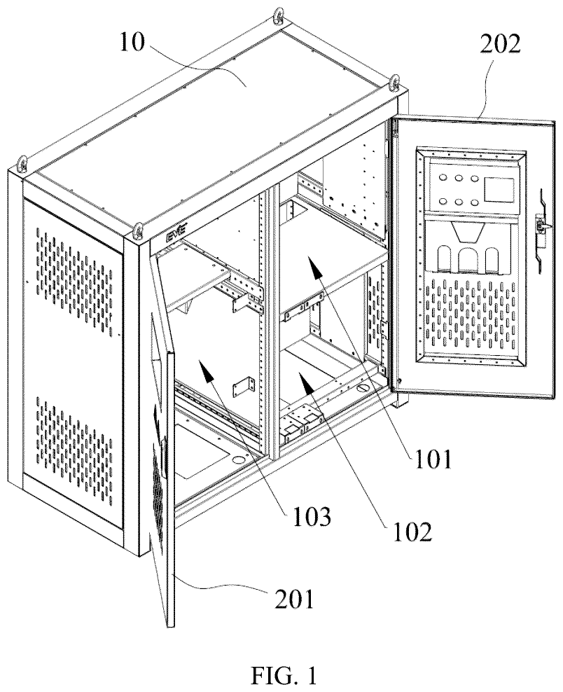

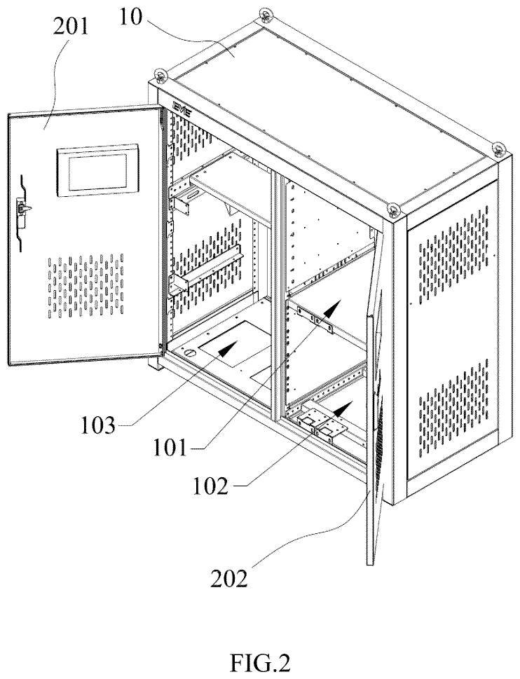

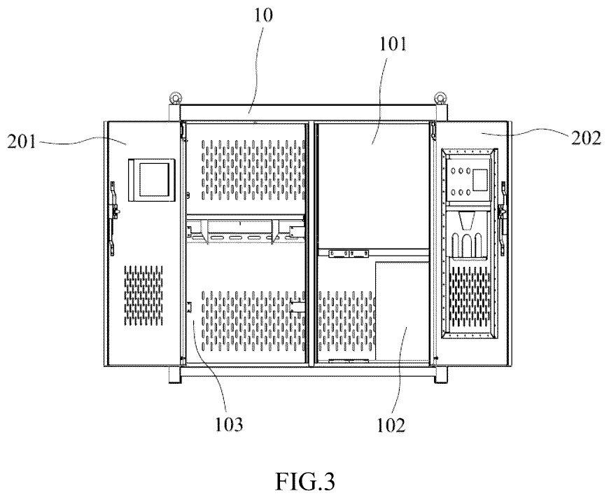

Referring to FIGS. 1 to 8, the present disclosure provides a combiner cabinet, including:
a cabinet body 10 provided with both a first isolation chamber 101 and a second isolation chamber 102; and
a cabinet door pivotally connected to the cabinet body 10 and configured to enclose the first isolation chamber 101 and the second isolation chamber 102;
where the first isolation chamber 101 and the second isolation chamber 102 are arranged in a preset first direction, the first isolation chamber 101 is provided with a first power distribution module 110, the second isolation chamber 102 is provided with an uninterruptible power supply 401, and the uninterruptible power supply 401 is provided with a backup battery 402, disposed close to the bottom of the cabinet body 10 and configured as a backup power supply of the battery management system.

In the present embodiment, the first direction may be a vertical direction of the combiner cabinet after installed, that is, the first isolation chamber 101 and the second isolation chamber 102 may be arranged from top to bottom, so that the second isolation chamber 102 is located in the lower portion of the combiner cabinet, while the uninterruptible power supply 401 may be provided in the second isolation chamber 102 and thus a storage battery of the uninterruptible power supply 401 may be provided in the second isolation chamber 102, thereby not only providing a backup power supply for the battery management system, but also solving the problem that the maintainability of the uninterruptible power supply 401 is poor due to provision of the uninterruptible power supply 401 at the top of the combiner cabinet to facilitate maintenance of the uninterruptible power supply 401, while avoiding the problem that the energy storage cabinet is faulty due to leakage of the uninterruptible power supply 401 to improve the reliability and safety of the energy storage system.

Meanwhile, a first power distribution module 110 may be provided in the first isolation chamber 101 and distribute an external power supply for use by the battery management system.

Where, main functions of the Battery Management System (BMS) include monitoring a battery state, controlling a charging process, distributing electric energy, protecting a battery, and the like.

The battery management system includes a main control module 701 responsible for functions such as collection of a total voltage and a total current, internal and external communication, fault recording, and decision-making; and a slave control module generally responsible for functions such as cell voltage collection, temperature collection, and balancing.

The combiner cabinet provided in the present disclosure not only has an efficient power distribution and management function, but also improves the reliability and safety of the battery management system with a modular design, and is suitable for various occasions requiring high-reliability power management and monitoring.

The combiner cabinet provided in the present disclosure includes the cabinet body 10 and the cabinet door, where the cabinet body 10 is provided with a first isolation chamber 101 and a second isolation chamber 102, the cabinet door is pivotally connected to the cabinet body 10 and configured to enclose the first isolation chamber 101 and the second isolation chamber 102. The first isolation chamber 101 and the second isolation chamber 102 are arranged along the preset first direction, the first isolation chamber 101 is provided with the first power distribution module 110, the second isolation chamber 102 is provided with the uninterruptible power supply 401, and the uninterruptible power supply 401 is disposed close to the bottom of the cabinet body 10 and configured as the backup power supply of the battery management system. As such, the backup power supply can be provided for the battery management system, and the uninterruptible power supply 401 is provided at a lower portion of the combiner cabinet, thereby solving a problem that the maintainability of the uninterruptible power supply 401 is poor due to provision of the uninterruptible power supply 401 at the top of the combiner cabinet to facilitate maintenance of the uninterruptible power supply 401, while avoiding a problem that the energy storage cabinet is faulty due to leakage of the uninterruptible power supply 401 to improve the reliability and safety of the energy storage system.

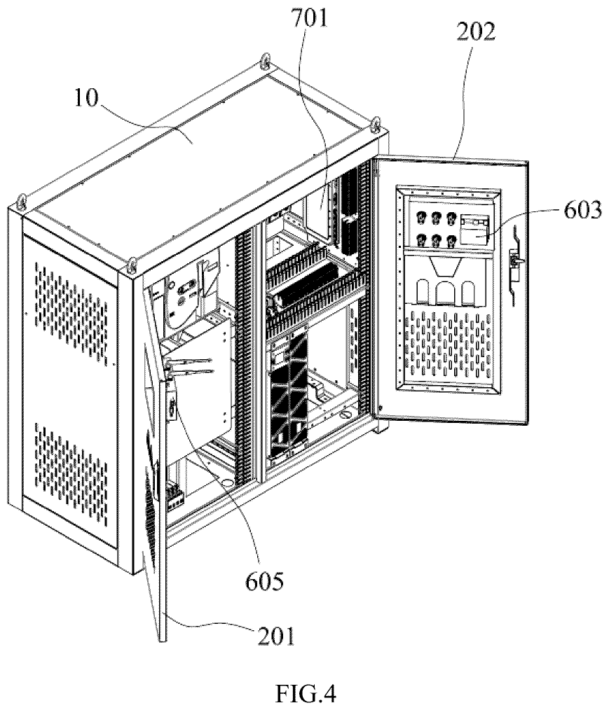

In some embodiments, as shown in FIG. 4, the main control module 701 of the battery management system is further provided in the first isolation chamber 101.

Specifically, the main control module 701 of the battery management system may be directly provided in the first isolation chamber 101 in the present disclosure, so that the combiner cabinet not only has an efficient power distribution and management function, but also improves the reliability and safety of the battery management system with a modular design, and is suitable for various occasions requiring high-reliability power management and monitoring.

In some embodiments, the first power distribution module 110 is an alternating current power distribution module.

In the present embodiment, the first power distribution module 110 may distribute an externally supplied alternating current power supply to the battery management system to provide an auxiliary power supply for the battery management system, thereby enabling efficient distribution and management of the power supply and ensuring stable operation and high efficiency of the battery management system.

It should be noted that the first power distribution module 110 may also be a direct current power distribution module, which may also be configured to power the battery management system to provide the auxiliary power supply to the battery management system.

In addition, the first power distribution module 110 may include both an alternating current power distribution module and a direct current power distribution module. The alternating current power distribution module and the direct current power distribution module may be individually installed in the main control box, so that isolation of the alternating current from the direct current can be realized, thereby improving the safety of the battery management system.

In some embodiments, as shown in FIGS. 1 to 8, the cabinet body 10 is further provided with a third isolation chamber 103, where the third isolation chamber 103 and the first isolation chamber 101 are arranged in a preset second direction, and a second power distribution module 120 is provided in the third isolation chamber 103.

Specifically, the second direction may be a left-right direction or a front-to-rear direction of the combiner cabinet after installed, that is, after the first isolation chamber 101 and the second isolation chamber 102 may be arranged from top to bottom, the third isolation chamber 103 and combiner of the first isolation chamber 101 and the second isolation chamber 102 may be arranged back-to-back or left-to-left.

In the present embodiment, the second power distribution module 120 may also be an alternating current power distribution module or/and a direct current power distribution module.

In some embodiments, the second power distribution module 120 may be a direct current power distribution module, and the first power distribution module 110 may be an alternating current power distribution module.

Where, when the first power distribution module 110 is the alternating current power distribution module and the second power distribution module 120 is the direct current power distribution module, the first power distribution module 110 may be configured to be electrically connected to an external power supply, and the second power distribution module 120 may be configured to be electrically connected to a cluster of batteries or a battery pack. That is, the first power distribution module 110 and the second power distribution module 120 are respectively located at both ends of the combiner cabinet.

In some embodiments, the second power distribution module 120 includes at least one of a main loop switch 501 and a protection switch 51.

In the present embodiment, the second power distribution module 120 may be a direct current power distribution module including both a main loop switch 501 and a protection switch 51, both of which are provided in the third isolation chamber 103.

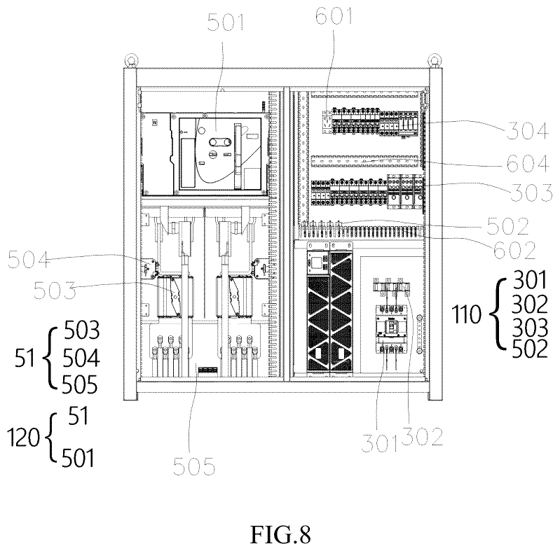

Specifically, as shown in FIG. 8, the main loop switch 501 may be an isolation switch, and the protection switch 51 may be a main loop fuse 503, a surge protector backup fuse 504, and a direct current surge protector 505.

The isolation switch, also referred to as “knife gate” is a switching device configured for circuit isolation in an electrical system, where a main function of the isolation switch is to physically disconnect the circuit to ensure that the circuit is completely powered off during maintenance and repair to prevent electric shock and other hazards. The isolation switch has no arc extinguishing capability and can divide and combine the circuit only without load current.

The main circuit fuse 503 is an electrical component configured to protect a high-capacity main feeder or a main circuit in a power distribution system. The main function of the main circuit fuse 503 is to melt a melt to cut off the circuit by heat generated by itself when a short circuit or a severe overcurrent occurs in the circuit, thereby preventing an accident from being enlarged and protecting equipment from being safe.

The surge protector backup fuse 504 may be used as a backup protection device for the surge protector, but its use needs to take into account the compatibility with the surge protector, the type and breaking capability of the fuse, and compliance with relevant standards and specifications.

The direct current surge protector (DC Surge Protection Device, SPD) 505 is a device for protecting electrical equipment from instantaneous overvoltages and lightning strikes, where a main function of the direct current surge protector is to limit the instantaneous overvoltages introduced into a power line or signal transmission line to a range of voltages that the equipment or system can withstand, or to drain a powerful lightning current into ground so as to protect the protected equipment or system from damage.

In some embodiments, as shown in FIGS. 1, 2, and 3, the cabinet door includes a first cabinet door 201 and a second cabinet door 202. The first cabinet door 201 and the second cabinet door 202 both are pivotally connected to the cabinet body (10), the first cabinet door 201 is configured to enclose the third isolation chamber 103, and the second cabinet door 202 is configured to enclose the first isolation chamber 101 and the second isolation chamber 102.

In the present embodiment, the first cabinet door 201 and the second cabinet door 202 are opposite doors, the first cabinet door 201 may be configured to enclose the third isolation chamber 103, that is, to enclose the direct current power distribution module in the third isolation chamber 103, and the second cabinet door 202 may be configured to enclose the first isolation chamber 101 and the second isolation chamber 102, that is, to enclose the alternate current power distribution module in the first isolation chamber 101 and the UPS power supply in the second isolation chamber 102.

In some embodiments, as shown in FIGS. 4, 5, 6, and 7, a display module of the battery management system is provided on the first cabinet door 201, and at least one of an operation module 801 and a status module 901 of the battery management system is disposed close to the main control module 701 of the battery management system on the second cabinet door 202.

In the present embodiment, the display module of the battery management system may be provided on the outer surface of the first cabinet door 201 and extend through the first cabinet door 201, and the operation module 801 and the status module 901 of the battery management system are provided on the outer surface of the second cabinet door 202 and extend through the second cabinet door 202.

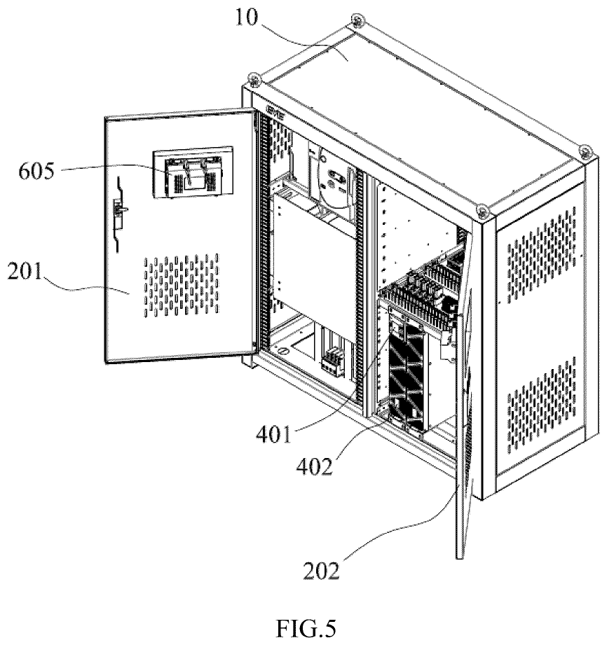

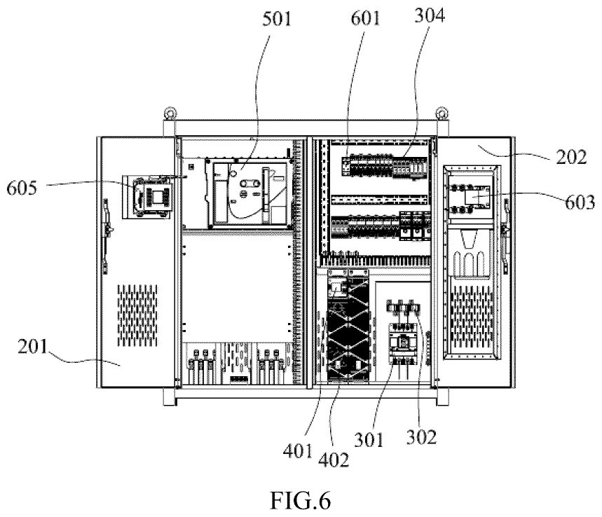

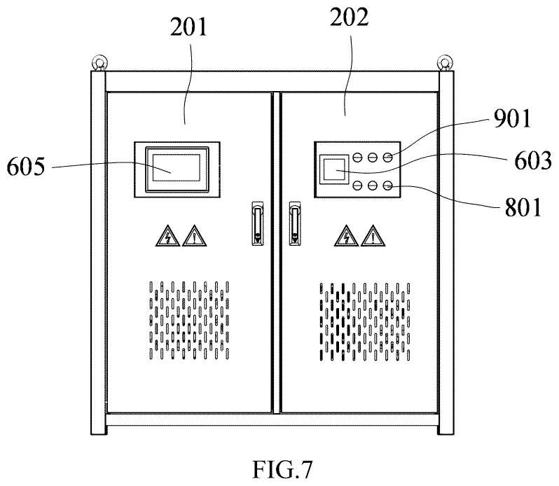

Specifically, as shown in FIG. 4, FIG. 5, FIG. 6, and FIG. 7, the display module may be a display screen 605, where the display screen 605 may be a display control screen of the battery management system, the operation module 801 may include an emergency stop button and an opening and closing button, the status module 901 may be an indicator lamp, and an electric meter 603 may also be provided on the second cabinet door 202.

The display control screen of the battery management system monitors and displays the status information of the battery in real time, and has a user-friendly interaction interface and various protection functions, thereby ensuring the safety and efficient management of the battery.

The emergency stop button is a device for rapidly stopping a battery management system in an emergency. The opening and closing button is configured to control a circuit to be turned on or off in the battery management system and widely used in various high-voltage and low-voltage circuit breakers. A main function of the opening and closing button is to manually or electrically close (turn on) and open (turn off) the circuit breaker.

The indicator lamp may indicate whether the battery management system is operated and whether the operation is normal.

In some embodiments, the first power distribution module 110 includes at least one of an incoming switch 301, a transformer 302, a direct current switch 303, and a delay switch 502.

In the present embodiment, the incoming switch 301 may be an alternating current incoming circuit breaker, the transformer 302 may be a current transformer, the direct current switch 303 may be a loop switch, and the delay switch 502 may be configured to control the battery management system to be turned on or off in a delay manner.

Specifically, as shown in FIGS. 4, 5, 6, and 8, the incoming switch 301 may be a molded case circuit breaker, the direct current switch 303 may be a miniature circuit breaker, and the delay switch 502 may be an intermediate relay.

Meanwhile, an alternating current surge protector 304 may be provided in the first isolation chamber 101.

In some embodiments, as shown in FIGS. 6 and 8, the first isolation chamber 101 is further provided with at least one of a socket 601 and a terminal row 602.

Specifically, the socket 601 may be a debugging socket 601, the terminal row 602 may be configured to connect components within the first isolation chamber 101, and the first isolation chamber 101 may also be provided with a wiring groove 604.

In some embodiments, a mounting member (not shown) is provided on a side of the cabinet body 10 away from both the first isolation chamber 101 and the second isolation chamber 102.

In the present embodiment, the mounting member includes a bearing portion provided with a first through-hole and a mounting portion provided with a second through-hole, where, after the combiner cabinet is beared by the bearing portion, the mounting member can be fixed to the combiner cabinet by passing through the first through-hole with a screw.

After the mounting portion is in contact with the energy storage cabinet, a screw may be used to pass through the second through-hole, so as to fix the combiner cabinet to the energy storage cabinet.

In addition, a plurality of heat dissipation holes may be provided on both left and right sides of the cabinet body 10 to facilitate heat dissipation of components in a main control box. A cable hole is provided at the bottom of the cabinet body 10, and a battery, a fire fighting system, a temperature control system, a lighting system, an external energy storage converter, and the like can be introduced from the cable hole.

In some embodiments, the present disclosure further provides an energy storage system that includes the combiner cabinet provided in the present disclosure.

Specifically, the energy storage system may be a battery prefabricated cabin battery energy storage system, which can effectively ensure safe and efficient operation of an energy storage item and provide important support for wide application of a renewable energy source.

What is claimed is:

1. A combiner cabinet, comprising:
a cabinet body provided with both a first isolation chamber and a second isolation chamber; and
a cabinet door pivotally connected to the cabinet body and configured to enclose the first isolation chamber and the second isolation chamber;
wherein the first isolation chamber and the second isolation chamber are arranged in a preset first direction, the first isolation chamber is provided with a first power distribution module, the second isolation chamber is provided with an uninterruptible power supply, and the uninterruptible power supply is disposed close to a bottom of the cabinet body and configured as a backup power supply of the battery management system.

2. The combiner cabinet of claim 1, wherein the first isolation chamber is further provided with a main control module of the battery management system.

3. The combiner cabinet of claim 1, wherein the cabinet body is further provided with a third isolation chamber, the third isolation chamber and the first isolation chamber are arranged in a preset second direction, and the third isolation chamber is provided with a second power distribution module.

4. The combiner cabinet of claim 2, wherein the cabinet body is further provided with a third isolation chamber, the third isolation chamber and the first isolation chamber are arranged in a preset second direction, and the third isolation chamber is provided with a second power distribution module.

5. The combiner cabinet of claim 3, wherein the second power distribution module is a direct current power distribution module.

6. The combiner cabinet of claim 3, wherein the second power distribution module comprises at least one of a main loop switch and a protection switch.

7. The combiner cabinet of claim 3, wherein the cabinet door comprises a first cabinet door and a second cabinet door; and
wherein the first cabinet door and the second cabinet door both are pivotally connected to the cabinet body, the first cabinet door is configured to enclose the third isolation chamber, and the second cabinet door is configured to enclose the first isolation chamber and the second isolation chamber.

8. The combiner cabinet of claim 7, wherein a display module of the battery management system is provided on the first cabinet door and disposed close to a main control module of the battery management system.

9. The combiner cabinet of claim 7, wherein at least one of an operation module and a status module of the battery management system is provided on the second cabinet door.

10. The combiner cabinet of claim 8, wherein at least one of an operation module and a status module of the battery management system is provided on the second cabinet door.

11. The combiner cabinet of claim 5, wherein the second power distribution module comprises at least one of a main loop switch and a protection switch.

12. The combiner cabinet of claim 6, wherein the cabinet door comprises a first cabinet door and a second cabinet door; and
wherein the first cabinet door and the second cabinet door both are pivotally connected to the cabinet body, the first cabinet door is configured to enclose the third isolation chamber, and the second cabinet door is configured to enclose the first isolation chamber and the second isolation chamber.

13. The combiner cabinet of claim 12, wherein a display module of the battery management system is provided on the first cabinet door and disposed close to a main control module of the battery management system.

14. The combiner cabinet of claim 12, wherein at least one of an operation module and a status module of the battery management system is provided on the second cabinet door.

15. The combiner cabinet of claim 7, wherein the cabinet door comprises a first cabinet door and a second cabinet door; and
wherein the first cabinet door and the second cabinet door both are pivotally connected to the cabinet body, the first cabinet door is configured to enclose the third isolation chamber, and the second cabinet door is configured to enclose the first isolation chamber and the second isolation chamber.

16. The combiner cabinet of claim 1, wherein the first power distribution module is an alternating current power distribution module.

17. The combiner cabinet of claim 16, wherein the first power distribution module comprises at least one of an incoming switch, a transformer, a direct current switch, and a delay switch.

18. The combiner cabinet of claim 1, wherein the first isolation chamber is further provided with at least one of a socket and a terminal row.

19. The combiner cabinet of claim 1, wherein a mounting member is provided on a side of the cabinet body away from both the first isolation chamber and the second isolation chamber.

20. An energy storage system, comprising a combiner cabinet, comprising:
a cabinet body provided with both a first isolation chamber and a second isolation chamber; and
a cabinet door pivotally connected to the cabinet body and configured to enclose the first isolation chamber and the second isolation chamber;
wherein the first isolation chamber and the second isolation chamber are arranged in a preset first direction, the first isolation chamber is provided with a first power distribution module, the second isolation chamber is provided with an uninterruptible power supply, and the uninterruptible power supply is disposed close to a bottom of the cabinet body and configured as a backup power supply of the battery management system.
